(19) United States
(12) Patent Application Publication
(10) Pub. No.: US 2007/0229770 A1
(43) Pub. Date: Oct. 4, 2007

(54) Electro-optic device fitting structure and projection type display device

(75) Inventors: Yasuyuki Miyata, Saitama-shi (JP); Teruaki Matsushima, Saitama-shi (JP)

Correspondence Address: BIRCH STEWART KOLASCH & BIRCH, PO BOX 747, FALLS CHURCH, VA, 22040-0747, US

(73) Assignee: FUJINON CORPORATION

(21) Appl. No.: 11/727,789

(22) Filed: Mar. 28, 2007

(30) Foreign Application Priority Data
Mar. 29, 2006 (JP) P2006-091235

(51) Int. Cl. G03B 21/00

(52) U.S. Cl. 353/33

(57) ABSTRACT

A first fixing plate 51, which is bonded to a G light prism 29 and which holds a G light DMD unit 50, is formed of a metal plate having a liner coefficient of expansion, which is substantially the same as that of the G light prism 29. The G light DMD unit 50 is fixed by inserting holding projections 51b into through holes 64 and inserting fixing holes 52a of a second fixing plate 52 into the holding projections 51b protruding through the through holes 64. The fixing holes 52a of the second fixing plate 52 have a shape similar to a section shape of the holding projections 51b taken along a plane perpendicular to the insertion direction. A gap between each holding projection 51b and the corresponding fixing hole 52a is uniform in an overall circumference. A thickness of the adhesive filled in this gap is uniform.

### BACKGROUND OF THE INVENTION

1. Technical Field

The invention relates to a structure for fitting an electro-optic device to a prism and a projection type display device having an optical system utilizing this fitting structure.

2. Description of the Related Art

The 3-chip projection type display device for projecting/displaying an image on a screen via a projection optical system by separating a white light (W light) emitted from a light source into three color lights of R light (red light), G light (green light), and B light (blue light), inputting respective color lights into a plurality of corresponding display devices (electro-optic devices) to modulate, and synthesizing respective modulated color lights again by a prism has been known.

As the display device, for example, the Digital Micromirror Device (hereinafter abbreviated as “DMD” (registered trademark)), the reflection type display device such as the reflection type liquid crystal panel, or the like, the transmission type display device such as the transmission type liquid crystal panel, or the like, etc. are employed.

In the 3-chip projection type display device, three sheets of display devices are used to modulate the RGB lights respectively. Therefore, in order to synthesize adequately the lights being modulated by respective display devices, an alignment adjustment to adjust positions of pixels between respective display devices is needed. In the projection type display device of the related art, the alignment adjusting mechanism for adjusting the alignment of respective display devices and the focus adjusting mechanism for adjusting positions of respective display devices with respect to the projection lens in the optical axis direction are incorporated, so that respective adjustments can be performed after a product of the projection type display device is completed.

However, in the above projection type display device of the related art, a cost of the projection type display device is increased because of a cost increase caused by the incorporation of the adjusting mechanisms. In order to solve this, JP Hei.6-118368 A discloses performing alignment adjustment in a state where respective display devices are temporarily fixed with respect to the prism, and then fixing/boding the respective display devices to the prism after the adjustment.

Also, JP Hei.10-010994 A (corresponding to U.S. Pat. No. 5,868,485) discloses bonding a fixing frame plate made of a metal thin film to a prism, then inserting projections provided on the fixing frame plate into holes of a panel frame body that holds display devices, and then fixing the respective display devices by filling an adhesive into the holes.

In still another projection type display device, projections are formed in a fixing frame plate being fixed to a prism as separate parts, the projections are passed through holes of the panel frame body, and then glass circular plates are inserted into the projections protruding from the holes and bonded thereto. In this case, the reason why the circular plates are made of glass is that the ultraviolet curing adhesive is employed.

In order to achieve better image quality, the projection type display devices employ a light source having large light quantity. Therefore, parts of the projection optical system are heated by a heat of the light source. In JP Hei.10-010994 A, because the fixing frame plate formed of a metal thin plate is bonded to the prism, a heat of the prism is transferred to the fixing frame plate. Normally, the glass constituting the prism and the metal have different liner coefficients of expansion, respectively. Therefore, there is a possibility that, due to the difference in liner coefficient of expansion between the glass and the metal, the fixing frame plate comes off from the prism or the prism is damaged.

Also, in JP Hei.10-010994 A, the projections are formed by bending a part of the fixing frame plate. Thus, a section shape taken along a plane perpendicularly to the projection inserting direction is a rectangle. In contrast, a hole shape on the panel frame body is a circle. Therefore, gaps between the projections and the holes and thicknesses of the adhesive filled in the gaps are not uniform. It is known that the ultraviolet curing adhesive shrinks in the curing caused when the ultraviolet rays are irradiated. Here, if the thickness of the adhesive is uneven, a difference in shrinkage may be caused and positions of the display devices may be deviated after the setting of the adhesive. Also, it may be considered that adhesive strength is weakened owing to unevenness of the thickness of the adhesive and the bonded portion peels off due to vibration, impact, or the like.

In addition, like the projection type display device of the related art, when the projections are formed as the separate parts and also the circular plates made of glass are used, cost is increased.

### SUMMARY OF THE INVENTION

The invention has been made in view of the above circumstances, provides an electro-optic device fitting structure that can prevent an electro-optic device from coming off due to a thermal expansion of a prism, the electro-optic device from displacing and adhesive strength from being reduced due to a shrinkage of an adhesive and also reduce cost, and also provides a projection type display device.

According to an aspect of the invention, an electro-optic device fitting structure includes a fixing member and a device fitting member. The fixing member is made of a material having a liner coefficient of expansion that is in a range of from 85% of a liner coefficient of expansion of a prism to 115% of the liner coefficient of expansion of the prism. The fixing member is bonded to a light incident plane of the prism. The device fitting member holds an electro-optic device that modulates light. The device fitting device is fitted to the fixing member.

According to another aspect of the invention, an electro-optic device fitting structure includes a first fixing member, at least one holding projection, a device fitting member, at least one through hole and at least one second fixing member. The first fixing member is fixed to a light incident plane of a prism. The at least one holding projection is provided integrally on the first fixing member. The device fitting member holds an electro-optic device that modulates light. The at least one through hole is formed in the device fitting member. The holding projection passes through the at least one through hole when the device fitting member is fitted to the first fixing member. The at least one second fixing member has a fixing hole into which the holding projection protruding through the device fitting member is inserted. The at least one second fixing member is bonded to the holding projection with an adhesive that is filled in the fixing hole. The fixing hole has a similar shape to a section shape of the holding projection taken along a plane perpendicular to a projection direction of the holding projection. A uniform gap into which the adhesive is filled is formed between the fixing hole and the holding projection.

In this case, the feature “the fixing member is made of the material having the liner coefficient of expansion that is in a range of from 85% of a liner coefficient of expansion of a prism to 115% of the liner coefficient of expansion of the prism” and the feature “the uniform gap is formed between the fixing hole and the holding projection” may employed separately or employed simultaneously.

Also, the adhesive may be a photo-curing adhesive that is cured by light irradiation. The second fixing member may be made of light transmission plastics.

Also, a projection portion fitted into the gap between the through hole and the holding projection, which is inserted into the through hole, may be formed on a surface of the second fixing member, which faces the device fitting member. Also, the device fitting member may includes a device substrate and a device fitting plate. The device substrate holds the electro-optic device and is electrically connected to the electro-optic device. In the device fitting plate, the through hole is formed. The device fitting plate is fitted to the electro-optic device or the device substrate. Furthermore, in the case where the device substrate has a shape to cover an upper portion of the through hole, openings or notches larger than an outer shape of the second fixing member are formed in a portion for covering the upper portion of the through hole.

Also, the electro-optic device may be a reflection type display device or a transmission type display device.

According to further another aspect of the invention, a projection type display device includes a light source, an electro-optic device, a prism and a projection optical system. The electro-optic device modulates light emitted from the light source. The electro-optic device is fitted to the prism. The prism refracts the light. The projection optical system projects the modulated light. The electro-optic device fitting structure described above is used to fit the electro-optic device to the prism.

With the above electro-optic device fitting structure and the projection type display device using this structure, the fixing member bonded to the prism is made of the material having a liner coefficient of expansion, which is in a range of from 85% of the liner coefficient of expansion of the prism to 115% of the liner coefficient of expansion of the prism. Therefore, the fixing member does not fall off from the prism due to the thermal expansion.

Also, a section shape of the holding projection taken along a plane perpendicular to the insertion direction of the holding projection and a shape of the fixing hole of the second fixing member are formed to be similar to each other. Therefore, a gap between the holding projection and the fixing hole and a thickness of adhesive filled in this gap can be formed uniformly. As a result, the adhesive shrinks uniformly in curing, so that displacement of the electro-optic device is not caused and also the second fixing plate and the holding projection can be bonded firmly.

Also, the second fixing member is formed of the light transmission plastics. Therefore, the second fixing member can be used at a low cost.

In addition, the projection portion fitted into the gap between the through hole and the holding projection, which is inserted into the through hole, is formed on the surface of the second fixing member, which faces the device fitting member. Therefore, the second fixing member can be fixed temporarily to prevent its coming-off until the adhesive is cured.

Also, the device fitting member includes the device substrate that holds the electro-optic device and the device fitting plate the first fixing member. Therefore, a load applied in fitting to the fixing member does not directly transfer to the electro-optic device or the device substrate. The electro-optic device and the wiring patterns on the device substrate are not damaged. Also, the openings or notches into which the second fixing member can be inserted are formed in the device substrate. Therefore, a size of the device substrate is not limited, and the device substrate of necessary size can be employed.

Also, the above fitting structure can be utilized for either the reflection type display device or the transmission type display device.

### BRIEF DESCRIPTION OF THE DRAWINGS

FIG. 1 is an external perspective view of a projection unit of a projection type display device according to an embodiment of the invention.

FIG. 2 is an exploded perspective view showing the configuration of the projection unit.

FIG. 3 is an explanatory view showing arrangement of a prism and a DMD.

FIG. 4 is an exploded perspective view showing a structure for fitting a DMD unit to the prism.

FIG. 5 is an explanatory view showing an insertion state between a holding projection and a through hole and an insertion state between the holding projection and a fixing hole.

FIG. 6 is a front view showing an insertion state of the second fixing plate and the holding projection.

FIG. 7 is an explanatory view showing a projection portion provided on a back surface of the second fixing plate.

FIG. 8 is a section view showing insertion states among the holding projection, the through hole, the fixing hole and the projection portion.

### DETAILED DESCRIPTION OF EMBODIMENTS OF THE INVENTION

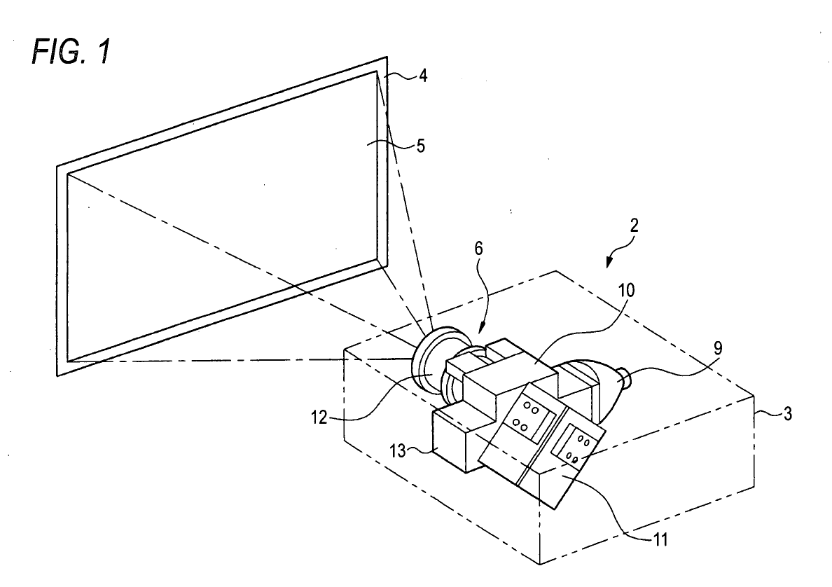

As shown in FIG. 1, a projection type display device 2 includes an almost box-shaped case 3, and a projection unit 6 incorporated into this case 3 to project an image 5 onto a screen 4. In this case, although not shown in detail, a control board for controlling the projection unit 6, a power supply circuit, etc. as well as the projection unit 6 are incorporated in the case 3.

The projection unit 6 is constructed by a light source lamp 9 for irradiating a white light, an integrator optical portion 10 for collecting the white light irradiated from the light source lamp 9 and transferring the light, a color separation/synthesis optical portion 11 for separating the white light transferred from the integrator optical portion 10 into three color lights of R light (red light), G light (green light), and B light (blue light), modulating respective lights in response to the image 5 to be projected/displayed, and synthesizing the modulated lights again, and a projection optical portion 12 for forming the image 5 by projecting the light synthesized by the color separation/synthesis optical portion 11 onto the screen 4. The integrator optical portion 10 is covered with a casing member 13 made of material having a light shielding property. The light source lamp 9, the color separation/synthesis optical portion 11, and the projection optical portion 12 are fitted to this casing member 13.

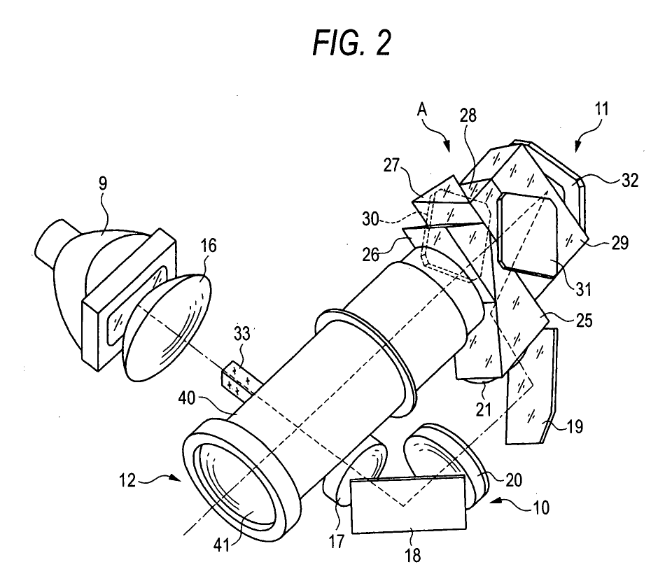

FIG. 2 is a perspective view showing a state where the casing member 13 of the projection unit 6 is removed. The integrator optical portion 10 is constructed by a first lens 16 arranged in front of the light source lamp 9, an integrator 33 arranged below the projection optical portion 12, a second lens 17, a first mirror 18 and a second mirror 19 for reflecting the white light to change the optical path, a third lens 20 arranged between the first mirror 18 and the second mirror 19, and a fourth lens 21 on which the light reflected by the second mirror 19 is incident. The integrator optical portion 10 collects the white light irradiated from the light source lamp 9 by means of the first to fourth lenses 16, 17, 20, 21 and the integrator 33, and input the light into the color separation/synthesis optical portion 11 by changing an optical path by the first and second mirrors 18, 19.

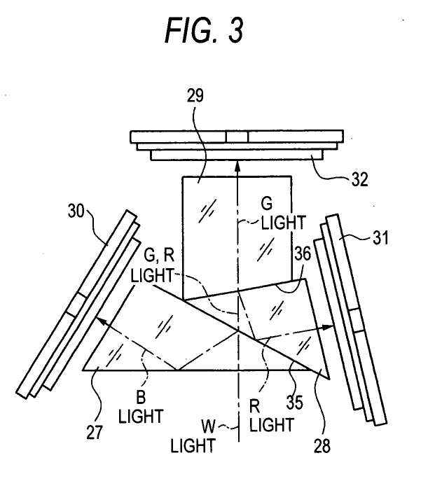

The color separation/synthesis optical portion 11 is constructed by a first total reflecting prism 25 and a second total reflecting prism 26 for totally reflecting the white light that is incident from the integrator optical portion 10, a B light prism 27, a R light prism 28, and a G light prism 29 for separating the white light being incident from the total reflecting prisms 25, 26 into the RGB lights and synthesizing these lights, and a B light DMD 30, a R light DMD 31, and a G light DMD 32 as the electro-optic devices (display devices) fitted to respective prisms to modulate the RGB lights. Also, as shown in FIG. 3 illustrating a state where the B light prism 27, the R light prism 28, and the G light prism 29 are viewed from an arrow A direction, dichroic mirror planes 35, 36 are provided between the B light prism 27, the R light prism 28, and the G light prism 29.

The white light (W light) incident from the total reflecting prisms 25, 26 is incident on the B light prism 27, and then the R light and the G light are transmitted selectively through the dichroic mirror plane 35. The B light reflected by the dichroic mirror plane 35 is totally reflected by the B light prism 27 and input into the B light DMD 30.

Also, the R light and the G light transmitted through the dichroic mirror plane 35 are incident on the R light prism 28, and then only the G light is transmitted selectively through the dichroic mirror plane 36. The R light reflected by the dichroic mirror plane 36 is totally reflected by the R light prism 28 and input into the R light DMD 31.

The G light transmitted through the dichroic mirror plane 36 is incident on the G light prism 29 and then incident on the G light DMD 32.

The DMD is the semiconductor device having a micro mirror array, as well known, and modulates the incident light by switching the reflection direction of the mirror array in response to the input signal to form the image. The RGB lights modulated by the B light DMD 30, the R light DMD 31, and the C; light DMD 32 are reflected by respective prisms 27, 28, 29, then incident on the total reflecting prisms 25, 26, and then synthesized again there. The synthesized light is incident on the projection optical portion 12.

The projection optical portion 12 is constructed by an almost circular cylinder-shaped lens barrel 40, plural sheets of projection lens 41 incorporated into this lens barrel 40, a focusing mechanism and a zooming mechanism for performing focus and zoom adjustments by moving the projection lens 41 in the lens barrel 40 in the optical axis direction, and the like. The projection optical portion 12 projects the light being incident from the color separation/synthesis optical portion 11 onto the screen 4 in an enlarged manner, and forms the image 5.

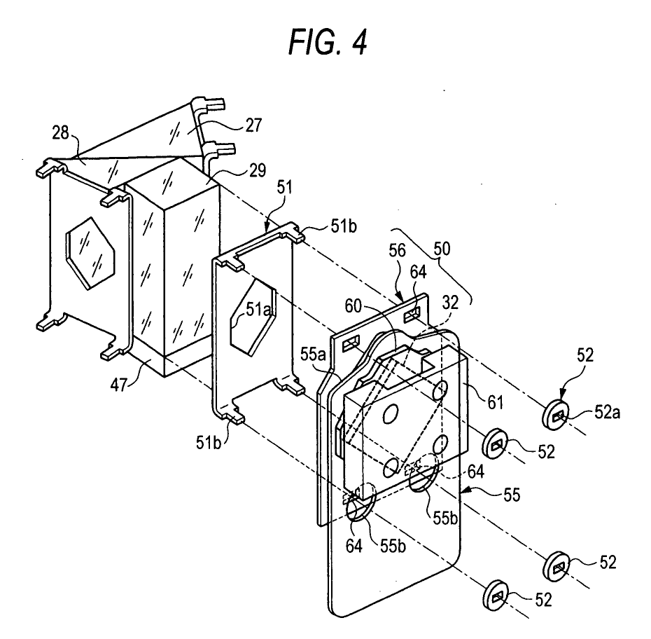

As shown in FIG. 4, respective prisms 25 to 29 of the color separation/synthesis optical portion 11 are fitted to a mount 47 with being cemented mutually. The mount 47 holds the respective prisms 25 to 29 and is used in fitting to the casing member 13.

The G light DMD 32 is fitted to a substrate and formed into a G light DMD unit 50, and the G light DMD unit 50 is fitted to the G light prism 29. Also, a first fixing plate 51 for holding the G light DMD unit 50 is fitted to the G light prism 29. Four second fixing plates 52 are used to prevent the G light DMD unit 50 from being separated from the first fixing plate 51. In this case, since the B light DMD 30 and the R light DMD 31 are fitted to the prism with the similar structure for the G light DMD 32, explanation of their fitting structure will be omitted herein.

The G light DMD unit 50 includes a device substrate 55 which holds the G light DMD 32 and on which wiring patterns connected electrically to the G light DMD 32 are provided, and a device fitting plate 56 which is fitted to the device substrate 55 or the G light DMD 32 and which is used in fitting to the first fixing plate 51. The device fitting member of the invention may include the device substrate 55 and the device fitting plate 56.

The G light DMD 32 is fitted to the back surface side of the device substrate 55. Although not shown in detail, an opening for exposing the fitting surface side of the G light DMD 32 is provided to the DMD fitting portion of the device substrate 55. A heat transfer plate 60 is fitted into this opening from the surface side of the device substrate 55 to contact the G light DMD 32. A heat sink 61 made of material such as aluminum, or the like having a good heat radiation property is fitted to the heat transfer plate 60, and a heat of the G light DMD 32 is radiated from this heat sink.

Four rectangular through holes 64 shaped long in the lateral direction are formed at four corners of the device fitting plate 56. These four through holes 64 are uses in fitting to the first fixing plate 51. In order not to block the upper side of the through holes 64, notches 55a are formed in an upper portion of the device substrate 55 and two openings 55b are formed in a lower portion of the device substrate 55.

The first fixing plate 51 is fitted to the G light prism 29 with an adhesive to constitute a first fixing member that holds the G light DMD unit 50. This first fixing plate 51 is made of a material having a liner coefficient of expansion, which is in a range of from 85% of a liner coefficient of expansion of the G light prism 29 to 115% of the liner coefficient of expansion of the G light prism 29. For example, in the case where the G light prism 29 is made of a glass (BK-7) having 7.3×10⁻⁶ (1/K) in the liner coefficient of expansion, the first fixing plate 51 may be made of nickel-iron alloy (7.0×10⁻⁶ (1/K)), titanium (8.0×10⁻⁶ (1/K)) or ceramics (about 7.0×10⁻⁶ to about 8.0×10⁻⁶ (1/K)). The values in the parentheses after the name of the materials represent linear coefficients of expansion of the respective materials. An opening 51a for allowing the G light to transmit to the G light DMD 32 is formed in the center portion of the fixing plate. Holding projections 51b for holding the G light DMD unit 50 are provided at four corners of the first fixing plate 51. Each holding projection 51b is formed by bending the end portion of the first fixing plate 51. A section shape of each holding projection 51b taken along a plane perpendicular to its projection direction is formed into a rectangular shape that is long in the lateral direction.

Since the first fixing plate 51 is fixed to the G light prism 29, a heat is also transferred to the first fixing plate 51 when the G light prism 29 is heated by the light source lamp 9. Unless a liner coefficient of expansion of the first fixing plate 51 is set so as to be substantially the same as that of the prism 29, the first fixing plate 51 may peel off from the prism 29 due to a difference in thermal expansion between the prism 29 and the first fixing plate 51. However, since the first fixing plate 51 of this embodiment generates a thermal expansion to the same extent as the G light prism 29 generates, the first fixing plate 51 does not peel off from the G light prism 29.

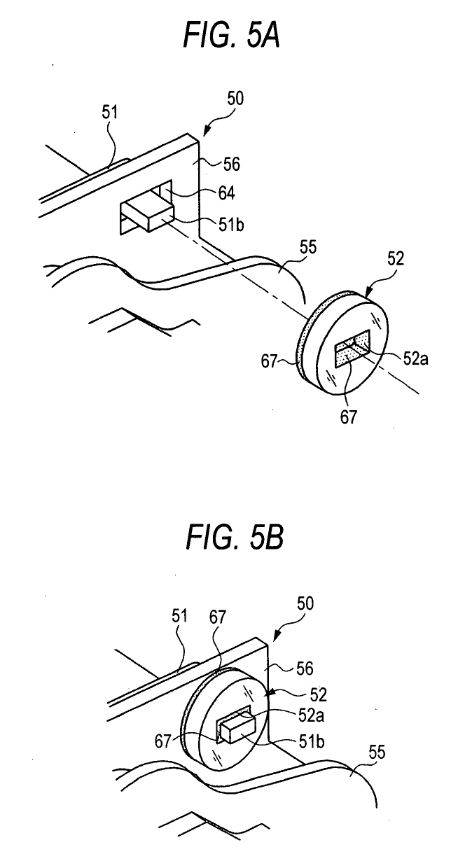

As shown in FIG. 5A, in fitting the G light DMD unit 50 to the first fixing plate 51, the holding projections 51b are inserted into through holes 64 of the device fitting plate 56. Since a length of the holding projections 51b is longer than a depth of the through holes 64, top ends of the holding projections 51b protrude from the front surface side of the device fitting plate 56. The second fixing plates 52 are fitted to the holding projections 51b, which protrude, respectively.

The second fixing plate 52 is formed of a circular plate made of transparent plastic. A fixing hole 52a formed into a similar shape to a section shape of the holding projection 51b is formed in the center portion of each second fixing plate 52. As shown in FIG. 5B, the second fixing plates 52 are inserted into the holding projections 51b in a state where the adhesive is filled in the fixing holes 52a.

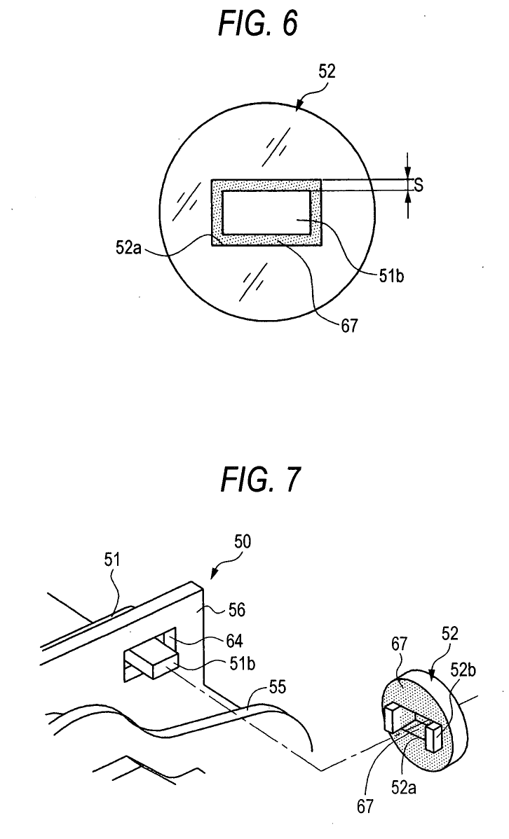

As shown in FIG. 6, a section shape of the holding projection 51b is similar to a shape of the fixing hole 52a. Therefore, gap S between the holding projection 51b and the fixing hole 52a is uniform around the entire circumference, so that a thickness of adhesive 67 filled in this gap S is also uniform. As a result, the adhesive 67 uniformed shrank in curing. Thus, displacement of the G light DMD 32 is not caused due to the shrinkage of the adhesive 67, unlike the fitting structure of the related art. Also, the second fixing plates 52 and the holding projections 51b can be bonded to each other firmly.

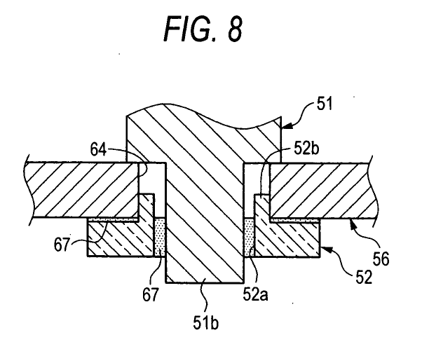

As shown in FIGS. 7 and 8, projection portions 52b to be fitted into the gap between the through hole 64 and the holding projection 51b are provided in vicinity of the fixing hole 52a on the back surface of the second fixing plate 52. Therefore, when the holding projection 51b is inserted into the fixing hole 52a, the second fixing plate 52 is temporarily fixed to the device fitting plate 56 by engagement between the through hole 64 and the projection portion 52b. As a result, the coming-off of the second fixing plate 52 can be prevented even if the adhesive 67 is not cured soon.

Here, the reason why the second fixing plate 52 is made of transparent plastics is that the ultraviolet curing adhesive can be employed as the adhesive 67 and that the ultraviolet rays can be irradiated onto the adhesive 67. Accordingly, a cost reduction can also be achieved rather than the case where the second fixing plate made of glass is used as in the related art. Also, the semi-transparent or opaque plastics may be employed if it can pass through the ultraviolet rays therethrough. Also, if the photo-curing adhesive is not employed, the opaque plastics may be employed.

Next, an operation of the above embodiment will be explained hereunder. Assembling of the projection unit 6 include: fitting the light source lamp 9 to the casing member 13 of the integrator optical portion 10, fitting the projection optical portion 12, fitting the color separation/synthesis optical portion 11, and performing alignment adjustment of the B light DMD 30, the R light DMD 31 and the G light DMD 32, for example.

Also, the fitting of the color separation/synthesis optical portion 11 includes fitting the mount 47, which hold holding the prisms 24 to 29, to the casing member 13, and fitting the B light DMD 30, the R light DMD 31 and the G light DMD 32 to the B light prism 27, the R light prism 28 and the G light prism 29, respectively.

For example, in fitting the G light DMD 32 to the G light prism 29, as shown in FIG. 4, the first fixing plate 51 is bonded to the G light prism 29. Then, the G light DMD unit 50 is fitted to the first fixing plate 51 so that the through holes 64 are passed through the holding projections 51b of the first fixing plate 51. Then, the second fixing plates 52 whose the fixing holes 52a are filled with the ultraviolet curing adhesive 67 are inserted into the holding projections 51b. As shown in FIGS. 7 and 8, at this time, the projection portions 52b provided on the back surfaces of the second fixing plates 52 are fitted into the through holes 64.

The B light and R light DMD units are fitted through the similar procedures, and alignment adjustment of the DMDs 30 to 32 is carried out. In this case, since the projection portions 52b are inserted into the through holes 64 and temporarily fixed, the second fixing plates 52 do not fall off during this alignment adjustment.

The ultraviolet rays are irradiated after the alignment adjustment, and thus the adhesive 67 filled in the second fixing plates 52 is cured. The ultraviolet curing adhesive 67 shrinks at a time of curing. In this case, as shown in FIG. 6, since the gap S between the holding projection 51b and the fixing hole 52a is set uniformly in an overall circumferential and also a thickness of the adhesive 67 filled in this gap S is sat uniformly, shrinkage of the adhesive 67 is generated uniformly. As a result, displacement of the DMDs 30 to 32 caused due to the uneven shrinkage does not occur. Also, the first fixing plate 51 and the second fixing plates 52 can be adhered firmly.

In some cases the projection type display device 2, after completed, is subjected to the long-time projection, or the like in answer to the using environment. If a difference in a liner coefficient of expansion resides between the prism and the fixing plate bonded to the prism, sometimes the fixing plate comes off from the prism when a temperature of the prism rises due to the long-time projection. However, in the invention, since a liner coefficient of expansion of the prism is set to the almost same extent as that of the fixing plate, such problem does not arise.

In the above embodiment, explanation is made by taking the 3-chip projection type display device as an example. The invention can also be applied to a 1-chip or 2-chip projection type display device. Also, explanation is made by taking the projection type display device using the DMD as an example. The invention can also be applied to the projection type display device using a reflection type liquid crystal panel or a transmission type liquid crystal panel. In this case, a polarization beam splitter must be arranged between the liquid crystal panel and the prism. The fitting structure of the invention can be utilized as a structure for fitting this polarization beam splitter to the liquid crystal panel.

Also, in the above embodiment, an example where the holding projections, the through holes, and the fixing holes are shaped into a rectangle is explained. The invention may contain a square, a triangle, a polygon, and a circle. Also, the fixing plate is explained as the discrete parts, but the fixing plate may be provided integrally or separately to the mount that holds the prism.

In addition, the invention that selects the metal having a liner coefficient of expansion, which is substantially the same as that of the prism as the material of the fixing plates and the invention that relates to the holding projections and the second fixing plates are carried out simultaneously. The invention can carry out only any one of these inventions. Also, an example where the display device such as the DMD, the liquid crystal panel, or the like is fitted to the prism is explained. But the fitting structure of the invention can be utilized in fitting other electro-optic device such as the imaging device, or the like to the prism.

What is claimed is:

1. An electro-optic device fitting structure comprising:
a fixing member made of a material having a liner coefficient of expansion that is in a range of from 85% of a liner coefficient of expansion of a prism to 115% of the liner coefficient of expansion of the prism, the fixing member bonded to a light incident plane of the prism; and
a device fitting member that holds an electro-optic device that modulates light, the device fitting device fitted to the fixing member.

2. An electro-optic device fitting structure comprising:
a first fixing member fixed to a light incident plane of a prism;
at least one holding projection provided integrally on the first fixing member;
a device fitting member that holds an electro-optic device that modulates light;
at least one through hole formed in the device fitting member, wherein the holding projection passes through the at least one through hole when the device fitting member is fitted to the first fixing member; and
at least one second fixing member having a fixing hole into which the holding projection protruding through the device fitting member is inserted, the at least one second fixing member bonded to the holding projection with an adhesive that is filled in the fixing hole, wherein:
the fixing hole has a similar shape to a section shape of the holding projection taken along a plane perpendicular to a projection direction of the holding projection, and
a uniform gap into which the adhesive is filled is formed between the fixing hole and the holding projection.

3. The electro-optic device fitting structure according to claim 2, wherein the first fixing member is made of a material having a liner coefficient of expansion that is in a range of from 85% of a liner coefficient of expansion of a prism to 115% of the liner coefficient of expansion of the prism.

4. The structure according to claim 2, wherein:
the adhesive is a photo-curing adhesive that is cured by light irradiation, and
the second fixing member is made of light transmission plastics.

5. The structure according to claim 2, wherein a projection portion fitted into the gap between the through hole and the holding projection, which is inserted into the through hole, is formed on a surface of the second fixing member, which faces the device fitting member.

6. The structure according to claim 1, wherein the device fitting member comprising:
a device substrate that holds the electro-optic device and is electrically connected to the electro-optic device; and
a device fitting plate in which the through hole is formed, the device fitting plate fitted to the electro-optic device or the device substrate.

7. The structure according to claim 6, wherein:
the device substrate has a shape to cover an upper portion of the through hole, and
openings or notches larger than an outer shape of the second fixing member are formed in a portion for covering the upper portion of the through hole.

8. The structure according to claim 2, wherein the device fitting member comprising:
a device substrate that holds the electro-optic device and is electrically connected to the electro-optic device; and
a device fitting plate in which the through hole is formed, the device fitting plate fitted to the electro-optic device or the device substrate.

9. The structure according to claim 8, wherein:
the device substrate has a shape to cover an upper portion of the through hole, and
openings or notches larger than an outer shape of the second fixing member are formed in a portion for covering the upper portion of the through hole.

10. The structure according to claim 1, wherein the electro-optic device is a reflection type display device or a transmission type display device.

11. The structure according to claim 2, wherein the electro-optic device is a reflection type display device or a transmission type display device.

12. A projection type display device comprising:
a light source;
an electro-optic device that modulates light emitted from the light source;
a prism to which the electro-optic device is fitted, the prism that refracts the light;
a projection optical system that projects the modulated light; and
the electro-optic device fitting structure according to claim 1 for fitting the electro-optic device to the prism.

13. A projection type display device comprising:
a light source;
an electro-optic device that modulates light emitted from the light source;
a prism to which the electro-optic device is fitted, the prism that refracts the light;
a projection optical system that projects the modulated light; and
the electro-optic device fitting structure according to claim 2 for fitting the electro-optic device to the prism.
